(19) United States
(12) Patent Application Publication
(10) Pub. No.: US 2007/0073651 A1
(43) Pub. Date: Mar. 29, 2007

(54) System and method for responding to a user query

(76) Inventor: Tomasz Imielinski, Princeton, NJ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,745

(22) Filed: Sep. 23, 2005

(51) Int. Cl. G06F 17/30

(52) U.S. Cl. 707/3

(57) ABSTRACT

This invention provides a system and method for responding to a user query. An identifier identifies an answer to a user query based on data in one or more structured data collections. A search engine in communication with the identifier searches, based on the answer, a systematically-generated, automatically-updated index of files to identify a file associated with the answer. A ranker in communication with the search engine ranks the identified files. A generator in communication with the search engine generates a response to the query based on a result of the searching. In one application, the system is used to provide an answer portal.

### TECHNICAL FIELD

This invention relates to computing devices and, in particular, to a system and method for responding to a user query.

### BACKGROUND

Today, searches for information are often driven by keywords. For example, when a user wants to obtain information regarding a certain topic, e.g. Bill Clinton's wife, the user inputs “Hillary Clinton” as a query. Conventional systems will then search for files containing the keywords “Hillary” and “Clinton,” finding files which address “Hillary Clinton” and perhaps her activities as a Senator, for example.

If the user instead inputs “Bill Clinton's wife” as the query, conventional systems will search for files containing the keywords “Bill,” “Clinton,” and “wife” instead. Such searches will often identify files which address “Bill Clinton” and perhaps his book, presidency, or other issues relating to him. Fewer of those files will address “Hillary Clinton” and her activities directly. Therefore, using conventional methods, the user must manually review and filter the search results to find the files directly addressing the answer to their query, i.e. “Hillary Clinton.” This review and filter process may be prohibitively time consuming and costly.

When a user is unaware of the answer to their question, conventional methods are even more problematic. For example, a user may want to obtain information about winners of the Masters. The user may not know that “the Masters” can refer to both a golf competition and a tennis competition. In conventional systems, if the user inputs “winners” and “Masters” as keywords, the user may receive a list of files containing the terms “winners” and “Masters.” However, some of those files may be related to the winners of the Golf Masters Tournament, e.g. Tiger Woods, and others may be related to winners of the Tennis Masters Cup, e.g. Roger Federer.

Therefore, what is needed is an improved system and method for responding to a user query.

### SUMMARY OF THE INVENTION

This invention provides a method for responding to a user query including identifying an answer to a user query based on data in a structured data collection; searching, based on the answer, a systematically-generated, automatically-updated index of remotely stored files to identify a file associated with the answer; and generating a response to the query based on a result of the searching. The identified file may be selected from the group consisting of: a web page, an image file, an audio file, a video file, a multi-media file, a word processing file, and a server page. The structured data collection may include a lookup table and identifying the answer may include accessing the lookup table to determine one or more terms relationally or functionally mapped to the query. Identifying the answer may include parsing the query to identify keywords; analyzing the structured data collection to identify one or more terms associated with the keywords; and outputting the one or more terms as the answer. When the structured data collection is a database, analyzing the database may include forming a database query based on the user query; and executing the database query against the database. Generating the response may include creating a document having a link to the file. The method may further include, when the searching identifies multiple files associated with the answer, ranking each of the multiple files. The ranking may include ranking a first file higher than a second file when the first file is associated with a greater subset of answer terms than the second file.

This invention also provides a machine readable medium having stored thereon a set of instructions, which when executed, perform a method including receiving a query originating from a user; identifying at least one answer to the query based on data in at least one structured data collection; transmitting the at least one answer to a search engine to search a bot-generated, bot-updated index of remotely stored files identifying files associated with the at least one answer; determining an order for the identified files; creating a document presenting the identified files based on the order; and transmitting the document to the user. Transmitting the at least one answer may include transmitting each answer separately to the search engine executing a separate search based on each answer. Determining the order for the files may include grouping together files identified in each separate search. The method may further include when the at least one structured data collection is categorized into multiple categories, asking the user to select a category; and identifying the at least one answer based primarily on data categorized into the selected category. Identifying the at least one answer may include parsing the query to identify keywords; analyzing the at least one structured data collection to identify, for each structured data collection, a set of terms associated with the keywords; comparing the sets; when non-empty sets substantially differ, outputting each substantially differing set as a separate answer; when non-empty sets are substantially similar, outputting the substantially similar sets as a single answer having multiple terms including terms of the substantially similar sets; and when each set is empty, outputting the keywords as the single answer. The method may further include when multiple answers are outputted, asking the user to select one of the multiple answers; and focusing searching to identify files associated with the selected answer.

The invention further provides a device for responding to a user query including an identifier to identify an answer to a user query based on data in a structured data collection; a search engine in communication with the identifier to search, based on the answer, a systematically-generated, automatically-updated index of remotely stored files identifying a file associated with the answer; and a generator in communication with the search engine to generate a response to the query based on a result of the searching. The generator may include a retriever to retrieve contents of the identified file; and a document creator in communication with the retriever to create a document presenting the contents. The contents may include at least one of: a news snippet, a review, an image, a blog entry, and a link. The generator may further include a statistics engine in communication with the document creator to determine statistics relating to the answer, the document further presenting the statistics.

The invention further provides a system for responding to a user query including a receiver to receive a query originating from a user; one or more structured data collections to relate answer terms and query keywords; an identifier in communication with the receiver and to the one or more structured data collections, the identifier to identify one or more answers to the query based on the answer terms and the query keywords related in the structured data collections; a search engine in communication with the identifier to search a bot-generated, bot-updated index of remotely stored files identifying files associated with at least one of the one or more answers; a ranker in communication with the search engine to rank the identified files; a document creator in communication with the ranker to create a document presenting the ranked files; and a transmitter in communication with the document creator to transmit the document to the user. The one or more structured data collections may include a structured data collection selected from the group consisting of: a database, a lookup table, an extensible markup language (XML) seed, a spreadsheet, a tab-delineated list, a comma-delineated list, a space-delineated list, a frequency asked questions (FAQ), and a knowledge base. The identifier may include a converter to convert the query into a query language associated with analyzing at least one of the structured data collections.

The invention further provides a method for providing an answer portal including forming a database query based on a natural language query; executing the database query against a database to determine an initial answer to the natural language query; searching, based on the answer, an index of remotely stored files to identify an initial set of files associated with the initial answer; presenting information associated with the initial answer in a document; providing network access to the document; and routinely and automatically updating the document, wherein updating the document includes: re-executing the database query to determine an updated answer; searching, based on the updated answer, the index to identify an updated set of files associated with the updated answer; and when the updated set of files differs from the initial set of files, updating the information in the document based on the updated answer and the updated set of files.

Presenting the information may include displaying the initial answer, and updating the information may include displaying the updated answer in place of the initial answer. Presenting the information may also include displaying a list listing at least a subset of the initial set of files, and updating the information may include altering the list to list at least a subset of the updated set of files.

Presenting the information may further include providing first content extracted from a file in the initial set of files, and updating the information may include providing, in place of the first content, second content extracted from a file in the updated set of files. Providing either the first content or the second content may include displaying a blog entry extracted from a blog, displaying a news snippet extracted from a news article, playing a song clip extracted from a music file, playing a video clip extracted from a video file, displaying a segment of text extracted from a web file or word processing file, and displaying a slide extracted from a multimedia file.

Presenting the information may further include embedding in the document a file in the initial set of files, and updating the information may include embedding in the document, in place of the file in the initial set of files, a file in the updated set of files. Embedding either the file in the initial set of files or the file in the updated set of files may include embedding at least one of: an image file, a music file, a video file, a multi-media file, an applet, a servlet, a web page, or a word processing file. Presenting the information may further include advertising a first service or product relating to the initial answer, and updating the information may include advertising a second service or product relating to the updated answer.

### BRIEF DESCRIPTION OF THE DRAWINGS

The invention is further described by way of examples with reference to the accompanying drawings, wherein:

FIG. 1 is a block diagram of a system for responding to a user query in accordance with one embodiment of this invention;

FIG. 2A is a block diagram illustrating the use of a relational lookup table forming part of the system;

FIG. 2B is a block diagram illustrating the use of a functional lookup table forming a part of the system;

FIG. 3 is a block diagram detailing components of an identifier in the system;

FIG. 4A is a block diagram illustrating one use of an analyzer of the system;

FIG. 4B is a block diagram illustrating another use of the analyzer of the system;

FIG. 5A is a block diagram illustrating one use of an outputter of the system;

FIG. 5B is a block diagram illustrating another use of the outputter;

FIG. 5C is a block diagram illustrating a further use of the outputter;

FIG. 5D is a block diagram illustrating yet a further use of the outputter;

FIG. 6A is a block diagram illustrating one use of a generator of the system;

FIG. 6B is a block diagram illustrating another use of the generator; and

FIGS. 7A-7B are screenshots of documents on a screen of a client computer of the system.

### DETAILED DESCRIPTION

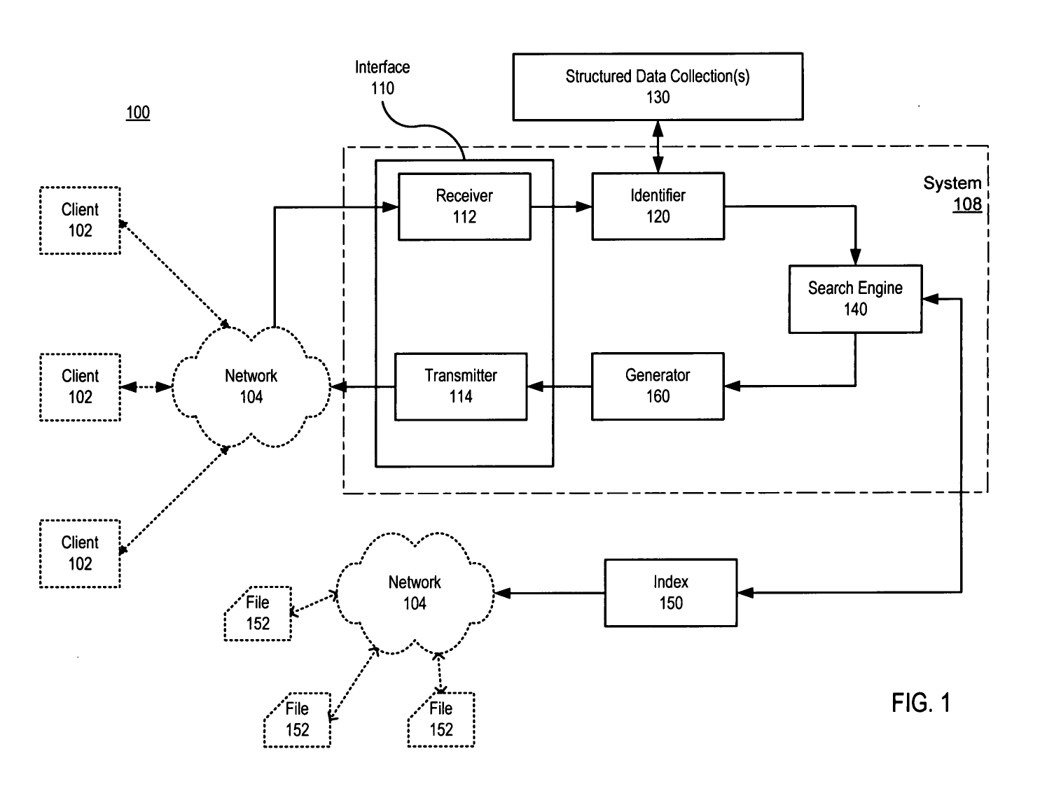

FIG. 1 illustrates an internet scheme 100 that includes a plurality of clients 102, a network 104 in the form of the Internet, a system 108 for responding to a user query in accordance with one embodiment of this invention, structured data collection(s) 130, an index 150, and remote files 152. The clients 102 are in communication with the system 108 through the network 104. Each client 102 may be, for example, a web browser on a client computer. The network 104 transmits communications from each client 102 to the system 108.

The system 108 includes a network interface 110, an identifier 120, a search engine 140, and a generator 160. The interface 110 includes a receiver 112 and a transmitter 114. The receiver 112 is in communication with the identifier 120. The identifier 120 is in communication with the structured data collection(s) 130 and the search engine 140. The search engine 140 is in communication with the index 150 and the generator 160. Together, the identifier 120, the search engine 140, and the generator 160 form a response to communications from a client 102, using the structured data collection(s) 130 and the index 150. The response is transmitted to the client using the transmitter 114.

In use, a user uses a client 102 to communicate a query through the network 104 to the system 108. The user query is in a natural language query format, rather than a structured query language (SQL) format, for example. For example, the user may use the client 102 to communicate the query “Bill Clinton's wife” or “Who is Bill Clinton's Wife” through the network 104 to the system 108. This communication is received at the receiver 112 at the interface 110. The communication includes data other than the query, such as metadata stored in a header. The receiver 112 transmits to the identifier 120 the query without this other data.

The identifier 120 uses the structured data collection(s) 130 to identify an answer to the query submitted by the user. The structured data collection(s) 130 may be or include, for example, a database, a lookup table, an extensible markup language (XML) seed, a spreadsheet, a tab-delineated list, the comma-delineated list, a space-delineated list, a frequently asked questions (FAQ), and a knowledge base. In the present example, the identifier 120 uses the structured data collection(s) 130 to identify “Hillary Clinton” as an answer to the user query “Bill Clinton's wife.” The answer “Hillary Clinton” is then transmitted to the search engine 140.

The search engine 140 uses the index 150 to search for one or more files associated with the answer “Hillary Clinton.” The index 150 is systematically generated and automatically updated. For example, the index 150 may be generated and updated by a bot. A bot is a software agent which interfaces with network services intended for people as if the bot were a real person. The bot automatically traverses the Internet on a regular basis (e.g. nightly) indexing files available on the Internet. The bot indexes the files by collecting file headers terms (e.g. metadata) which describe the contents of a file.

The search engine 140 bases the search of the index 150 on the answer (e.g. “Hillary Clinton”), rather than on the query (e.g. “Bill Clinton's wife”), thereby focusing the search on the answer to the query rather than on the query itself. Because the search is based on the answer rather than the query, the search is more likely to identify the files in the files 152 sought by the user.

The remote files 152 are indexed by the index 150 and may be or include, for example, web pages, word processing files, image files, audio files, and video files. These files are remotely located on various servers accessible via the network 104.

An indexed file may not be immediately accessible via the network 104, but is still indexed (e.g. using the bot) to indicate the file's existence. Additionally, a file 152 may be accessible via a different network (not shown) in addition to or alternatively to being accessible via the network 104.

In the present example, the search engine 140 transmits the results of the searching based on the answer “Hillary Clinton” to the generator 160. The generator 160 generates a response to the original query based on these results. In one application, the generator 160 creates a document having a link to one or more of the files identified in the search, e.g. an article discussing New York senators. The transmitter 114 transmits the response generated by the generator 160 to the client 102 via the network 104.

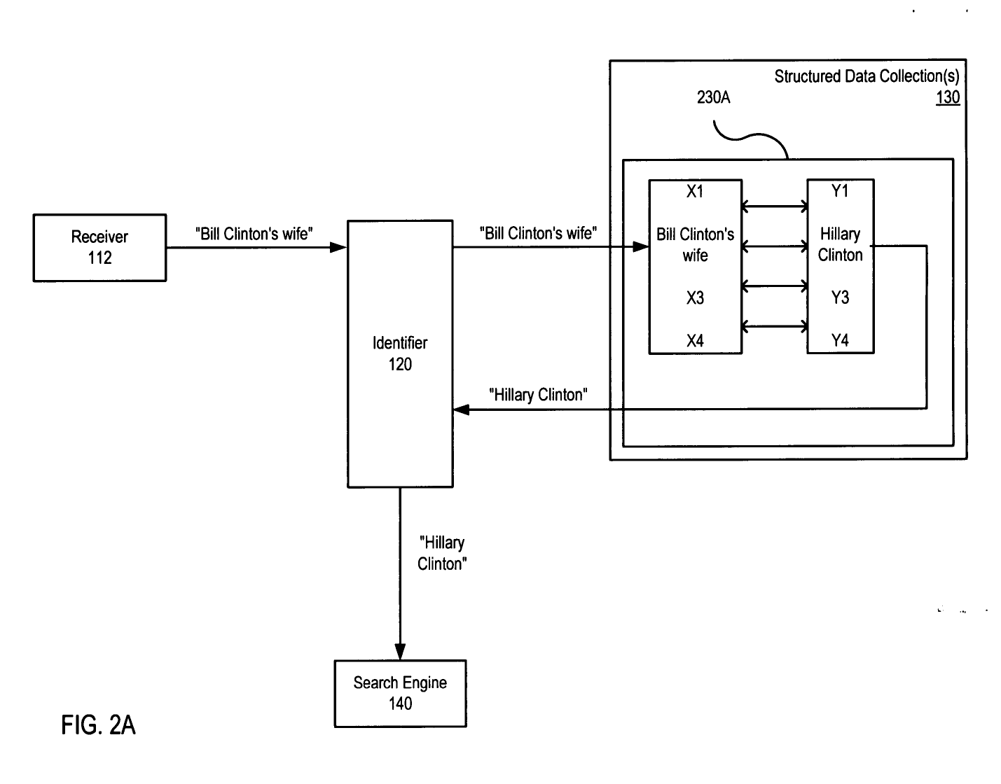

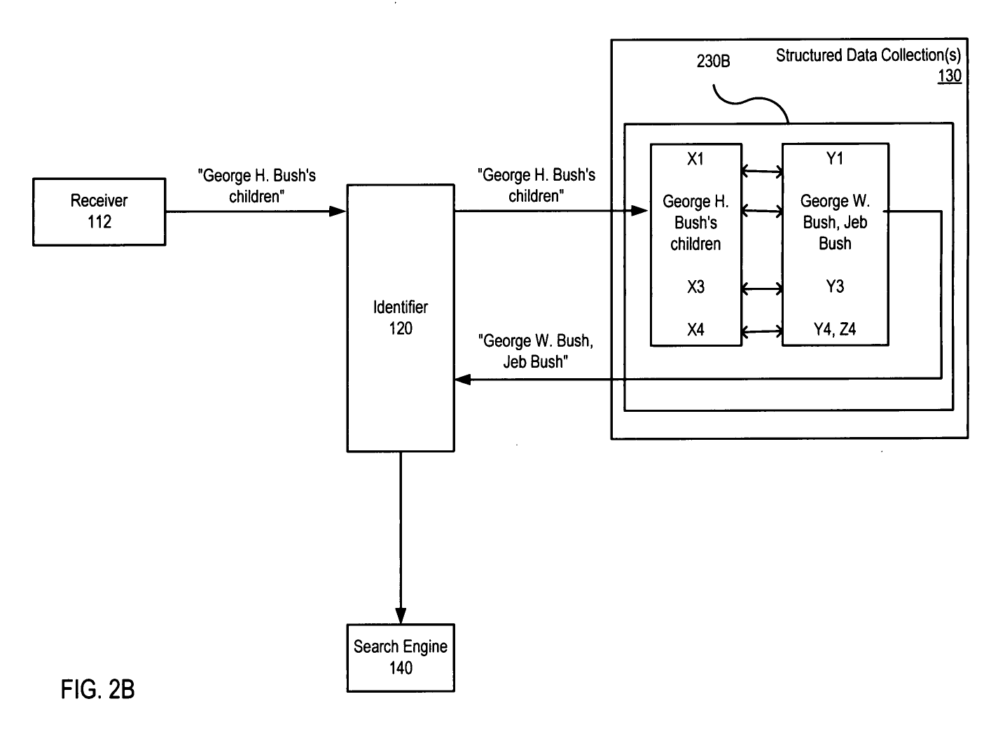

FIG. 2A illustrates the use of a relational lookup table by the identifier 120 to identify an answer to a query. In FIG. 2A, the structured data collection(s) 130 include a relational lookup table 230A. As used herein, a relational lookup table is a structured data collection that provides a one-to-one mapping between a query (or keywords of the query) and an answer to the query. In FIG. 2A, the relational lookup table 230A maps queries (or keywords of the queries) to answers. Specifically, the relational lookup table 230A maps X1 to Y1, “Bill Clinton's wife” to “Hillary Clinton”, X3 to Y3, and X4 to Y4.

In use, the receiver 112 communicates with the identifier 120 to transmit a query received from a user. The identifier 120 communicates with the relational lookup table 230A to identify an answer to the user query. The identifier 120 then transmits the answer to the search engine 140.

For example, in FIG. 2A, the receiver 112 transmits the query “Bill Clinton's wife” to the identifier 120. The identifier 120 uses the relational lookup table 230A to determine that “Bill Clinton's wife” is mapped to the answer “Hillary Clinton.” For example, the identifier 120 may match the query “Bill Clinton's wife” to a phrase in a row and column of a lookup table. The identifier 120 may then determine that the answer “Hillary Clinton” is listed in another column in that row. The identifier 120 then transmits the answer “Hillary Clinton” to the search engine 140. The search engine 140 searches for files associated with “Hillary Clinton” based on the answer “Hillary Clinton” rather than based on the query “Bill Clinton's wife.”

FIG. 2B illustrates the use of a functional lookup table by the identifier 120 to identify an answer to a query. In FIG. 2B, the structured data collection(s) 130 includes a functional lookup table 230B. As used herein, a functional lookup table is a structured data collection that provides one-to-one and one-to-many mappings between queries (or keywords of queries) and answers to the queries. In FIG. 2B, the functional lookup table 230B maps X1 to Y1, “George H. Bush's children” to “George W. Bush, Jeb Bush”, X3 to Y3, and X4 to Y4, Z4.

In use, the receiver 112 communicates with the identifier 120 to transmit a query received from a user. The identifier 120 communicates with the functional lookup table 230B to identify an answer to the user query. The identifier 120 then transmits the answer to the search engine 140.

For example, in FIG. 2B, the receiver 112 transmits the query “George H. Bush's children” to the identifier 120. The identifier 120 uses the functional lookup table 230B to determine that “George H. Bush's children” is mapped to the answer “George W. Bush, Jeb Bush.” The identifier 120 then transmits the answer “George W. Bush, Jeb Bush” to the search engine 140. The search engine 140 searches for files associated with the answer “George W. Bush, Jeb Bush,” based on the answer “George W. Bush, Jeb Bush” rather than based on the query “George H. Bush's children.”

As can be understood from both FIGS. 2A and 2B, an answer to a query may include multiple terms. In FIG. 2A, the answer includes the terms “Hillary” and “Clinton.” In FIG. 2B, the answer includes that terms “George,” “W.,” “Bush,” “Jeb,” and “Bush.”

Terms are grouped into sets of terms separated by a delineator (e.g. a comma or a semicolon). In FIG. 2A, the answer includes one set of terms “Hillary Clinton.” In FIG. 2B, the answer includes two sets of terms, “George W. Bush” and “Jeb Bush.” A set of terms may have a single term or a plurality of terms. For example, an answer to the query “Female Pop Divas” may include a set of terms having a single term, e.g. “Cher” or “Madonna,” as well as a set of terms having a plurality of terms, e.g. “Britney Spears.”

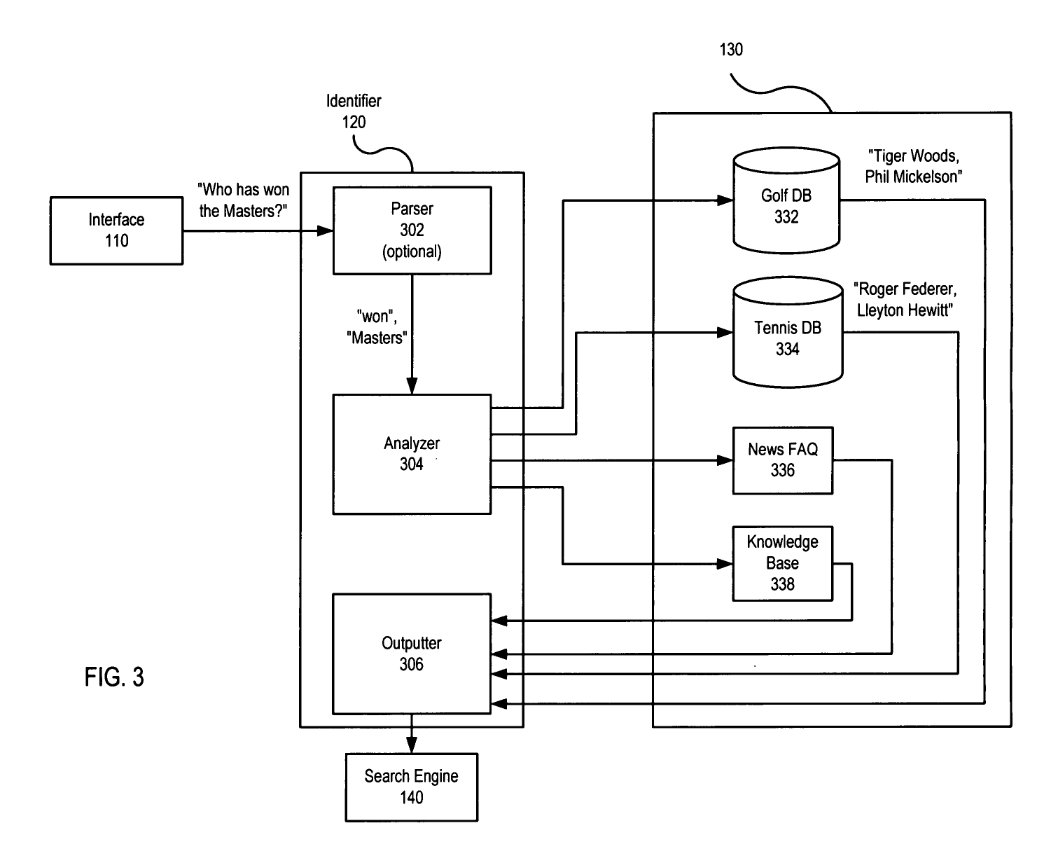

FIG. 3 illustrates components of the identifier 120 and their interaction with multiple structured data collection(s) in the structured data collection(s) 130. The identifier 120 includes an optional parser 302, an analyzer 304, and an outputter 306. In FIG. 3, the structured data collection(s) 130 include a Golf database (DB) 332, a Tennis database (DB) 334, a News FAQs 336, and a Knowledge Base 338.

In use, the interface 110 transmits a query received from a client 102 to the parser 302. The parser 302 identifies keywords in the query and transmits these keywords to the analyzer 304. The analyzer 304 analyzes the structured data collection(s) 130 to identify one or more terms associated with the keyword. Answers from each of these structured data collections are communicated to the outputter 306.

For example, in FIG. 3, the interface 110 transmits to the parser 302 the query “Who has won the masters?” The parser 103 parses the query “Who has won the masters?” identifying the keywords “won” and “masters.” The parser 302 sends the keywords “won” and “Masters” to the analyzer 304.

In an alternative embodiment, the parser 302 is external to, but in communication with, the identifier 120. In such an embodiment, the interface 110 may transmit the query to the external parser, receive the keywords in response, and then deliver the keywords to the analyzer 304.

In FIG. 3, the analyzer 304 analyzes each of the structured data collections in structured data collection(s) 130, i.e. the Golf DB 332, the Tennis DB 334, the News FAQs 336, and the Knowledge Base 338, to identify one or more terms associated with the keywords “won” and “masters.” In FIG. 3, the Golf DB 332 and the Tennis DB 334 each provide an answer to the query “Who has won the masters?” The news FAQs 336 and the knowledge base 338 provide no answers to the query.

In FIG. 3, the results of the analysis are provided to the outputter 306 (e.g. directly or via the analyzer 304).

As can be understood from FIG. 3, different structured data collections may provide different answers to the same query. In the present example, the Golf DB 332 and the Tennis DB 334 each provide a different answer to the query “Who has won the masters?” since, as mentioned above, “masters” can be associated with more than one competition. The Golf DB 332 provides the answer having the sets of terms “Tiger Woods” and “Phil Mickelson,” two golfers who have won the Golf Masters Tournament. The Tennis DB 334 provides another answer having the sets of terms “Roger Federer” and “Lleyton Hewitt,” two tennis players who have won the Tennis Masters Cup. Both these answers are provided to the outputter 306. Based on these answers, the outputter 306 transmits one or more sets of terms in the answers to the search engine 104.

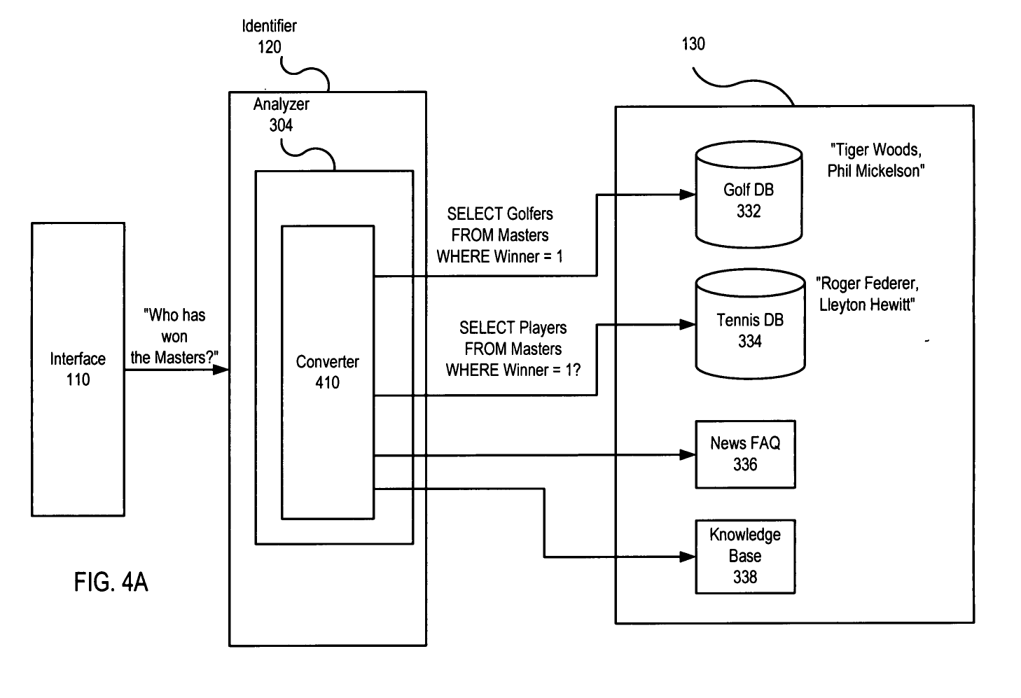

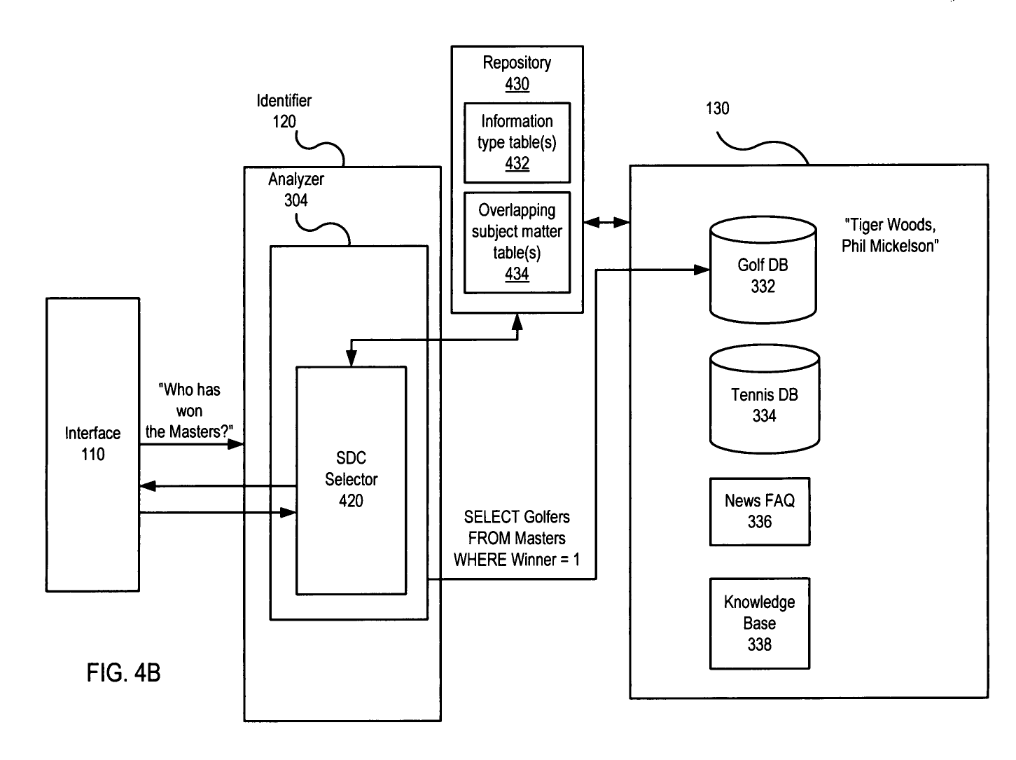

FIG. 4A illustrates one use of the analyzer 304 of the identifier 120. In FIG. 4A, the analyzer 304 includes a converter 410 in communication with each of the structured data collections of the structured data collection(s) 130.

In use, the converter 410 receives a query from a client 120 via the interface 110. The converter 410 converts the query (or keywords of the query) into a format appropriate for the structured data collection being analyzed.

For example, the converter 410 converts the query “Who has won the Masters?” to multiple formats, one for each of the structured data collections 332, 334, 336, and 338. Specifically, the converter 410 converts the user query into one or more database queries, e.g. one or more Structured Query Language (SQL) statements, appropriate for the structure data collection being analyzed. For example, in FIG. 4A, converter 410 converter the user query into a first SQL statement appropriate for the Golf DB 332, e.g. “SELECT Golfers FROM Masters WHERE Winner=1.” The converter 410 also converts the query into a second SQL statement appropriate for the Tennis DB 334, e.g. “SELECT Players FROM Masters WHERE Winner=1.” The first and second SQL queries are executed against the corresponding databases, i.e. the Golf DB 332 and the Tennis DB, respectively, sequentially or in parallel. Additionally, the converter 410 converts the query “Who has won the Masters?” to appropriate formats for use in analyzing each of the FAQ 336 and the Knowledge Base 338.

In one use of the converter 410, a parser in the converter 410 identifies keywords in the query to facilitate converting the query into an appropriate format. In another use of the converter 410, the converter 410 converts keywords identified by the parser 302 into the appropriate format rather than converting the query directly.

FIG. 4B illustrates another use of the analyzer 304 of the identifier 120. In FIG. 4B, the analyzer 304 includes a structured data collection (SDC) selector 420 to select among the structured data collections in the structured data collection(s) 130.

In use, after the identifier 120 receives a query from the user via the interface 110, the analyzer 304 in the identifier 120 recognizes that an answer to the query may be provided by multiple structured data collections. For example, in FIG. 4B, after the identifier 120 receives the query “Who has won the Masters?”, the analyzer 304 recognizes that an answer to the query may be provided by both the Golf DB 332 and the Tennis DB 334 using a collection of data forming part of the system 108. In FIG. 4B, the collection of data is in the form of a repository 430. The repository 430 describes the available structured data collections. The repository 430 includes information type table(s) 432 and overlapping subject matter table(s) 434.

The information type table(s) 432 describes the type of information available in the structured data collection(s) 130. For example, in FIG. 4B, the information type table(s) 432 indicates that one SDC provides answers to queries relating to golf and another SDC provides answers to queries relating to tennis.

The overlapping subject matter table(s) 434 indicates overlapping subject matter. For example, in FIG. 4B, the overlapping subject matter table(s) 434 indicates that multiple SDCs provide answers to queries having the terms “masters.”

Prior to analyzing the structured data collection(s) 130, the analyzer 304 directs the SDC selector 420 to select one or more of the structured data collection(s) 130 for analysis. In one configuration, the SDC selector automatically selects one or more of the structured data collection(s) 130 based on previous queries from the same user and/or a user profile. In another configuration, the SDC selector 420 communicates via the interface 110 to the user, requesting that the user select one or more structured data collections.

In one application, the system 108 is configured to reveal the identity of structured data collections to users. In that application, the SDC selector 420 provides the user with a selection of structured data collections, e.g. a limited selection of the databases having relevant overlapping subject matter. The selection may include, for example, the Golf DB 332 and the Tennis DB 334, but not include the News FAQ 336 or the Knowledge Base 338. Selecting an SDC results in the analyzer 304 analyzing the selected SDC without analyzing the other SDCs.

In another application of the invention, the system 108 is configured to hide to the identity of structured data collections to users. In that application, the SDC selector 420 provides the user with a selection of categories without identifying the specific SDCs. The SDC selector 420 instead requests that the user select between various categories.

Some of the categories may be associated with multiple SDCs. For example, a “Sports” category may be associated with both golf and tennis. Therefore, selecting one category may result in analyzing multiple SDCs. For example, selecting the “Sports” category may result in analyzing both the Golf DB 332 and the Tennis DB 334.

In FIG. 4B, the user's selection is received at the interface 110 and transmitted to the SDC selector 420. Based on the selection, the analyzer 304 analyzes the relevant structured data collections.

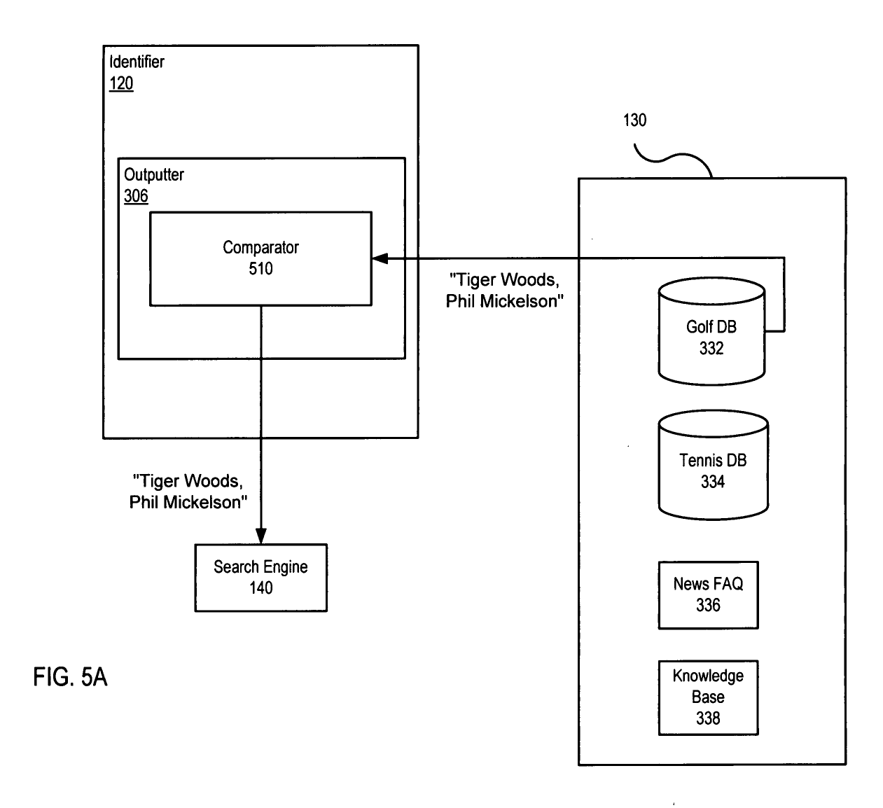

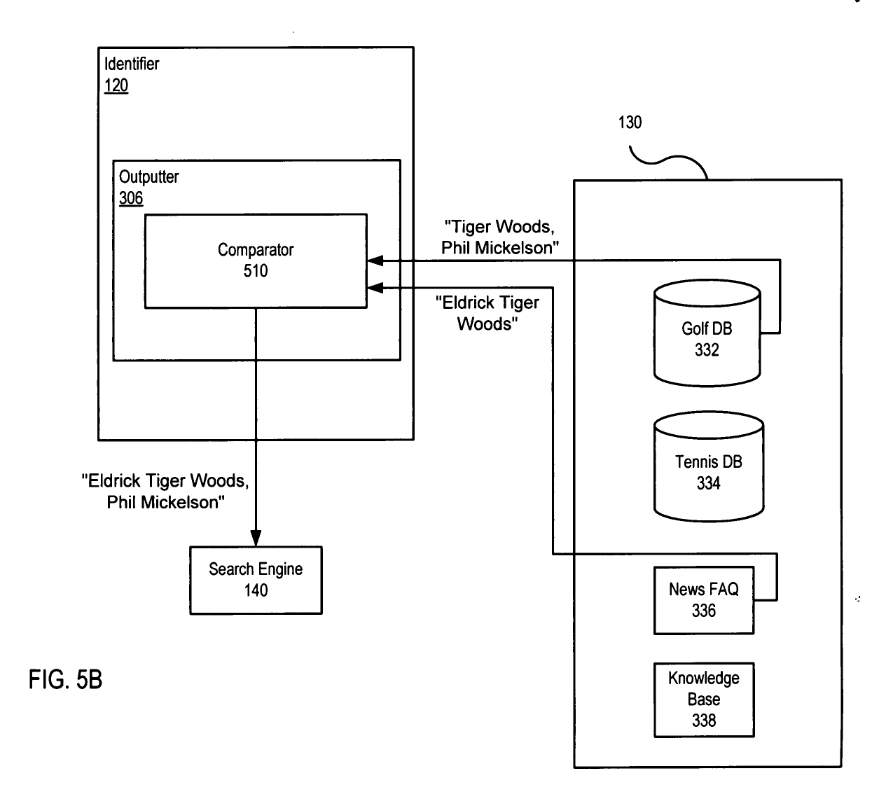

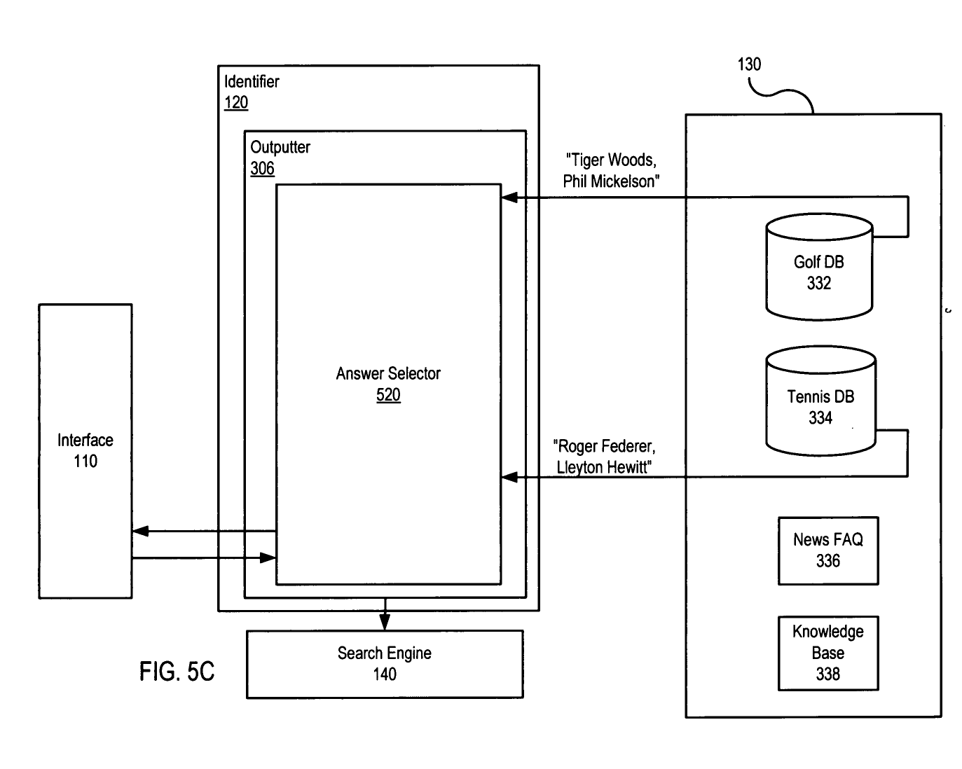

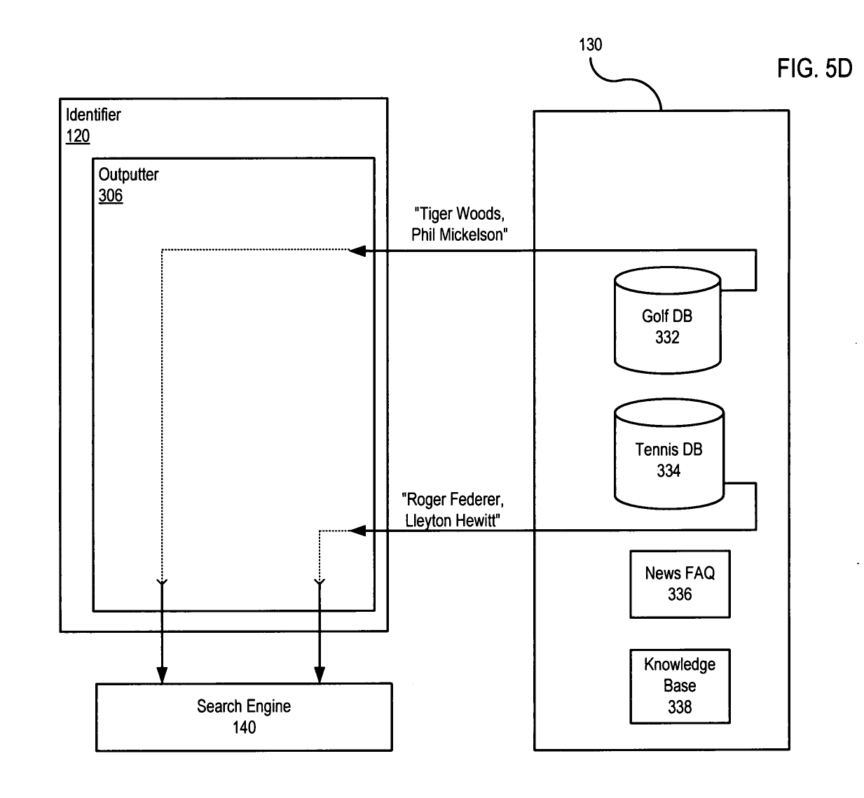

FIG. 5A illustrates one use of the outputter 306 of the identifier 120 to output an answer to the search engine 140. In FIG. 5A, the outputter 306 includes a comparator 510. The comparator 510 is in communication with the structured data collection(s) 130 and with the search engine 140. The comparator 510 compares answer terms identified using the structured data collection(s) 130 and determines the answer(s) to provide to the search engine 140.

In use, the comparator 510 receives search results provided by the structured data collection(s) 130. When the comparator 510 receives no answers from the structured data collection(s) 130 (e.g. each returned set of terms is empty), the comparator 510 outputs the query (or keywords of the query) as the answer to the search engine.

When comparator 510 receives one answer with multiple sets of terms (i.e. “Tiger Woods, Phil Mickelson”), the comparator 510 compares the sets of terms to determine if they substantially differ. In FIG. 5A, the comparator compares “Tiger Woods” against “Phil Mickelson.”

When the sets of terms in an answer substantially differ, the outputter 306 transmits the answer to the search engine 140 without substantive modification. The search engine 140 then searches for files associated with the differing sets of terms, i.e. associated with the entire answer rather than a subset of the answer. In the present example, the search engine 140 searches for files associated with both “Tiger Woods” and “Phil Mickelson,” rather than one or the other.

When sets of terms in one or more answers are substantially similar, the outputter 306 may modify the terms transmitted before transmitting an answer to the query to the search engine 140, as seen in FIG. 5B.

FIG. 5B illustrates a use of the outputter 306 when the sets of terms in answers from two structured data collections have substantially similarity. In FIG. 5B, two answers to the query “Who has won the Masters?” is identified. One answer is provided by Golf DB 332: “Tiger Woods, Phil Mickelson.” Another answer is provided by the News FAQ 336: “Eldrick Tiger Woods.”

In FIG. 5B, the comparator 510 compares the sets of terms and determines that the set “Tiger Woods” substantially differs from the set “Phil Mickelson.” However, the comparator 510 also determines that the set “Tiger Woods” is substantially similar to the set “Eldrick Tiger Woods”, e.g. because “Eldrick Tiger Woods” includes “Tiger Woods”. The comparator 510 outputs “Eldrick Tiger Woods, Phil Mickelson” as the answer rather than outputting “Tiger Woods, Phil Mickelson, Eldrick Tiger Woods” as the answer.

Thus, although two answers are initially identified, one using the Golf DB 323 and one using the News FAQ 336, because some terms of the two answers have substantial similarity, one single answer is transmitted to the search engine 140 rather than two answers. The single answer is a combination of terms of the two answers. The search engine 140 searches for files associated with this intelligently combined answer. Accordingly, in certain applications, when outputting an answer to the search engine 140, the outputter 306 may output a single answer which includes the terms of substantially similar sets of terms from a plurality of identified answers.

FIG. 5C illustrates another use of the outputter 306 of the identifier 120. In FIG. 5C, the outputter 306 includes an answer selector 520. The answer selector 520 is in communication with structured data collection(s) 130 (either directly or via another component in the identifier 120, such as the comparator 510) to receive answers to queries. In certain applications, rather than transmitting the multiple identified answers as a single answer to the search engine, the outputter 306 is configured to use the answer selector 520 to select an answer from among the multiple identified answers. The outputter 206 then transmits the selected answer to the search engine 140.

In one configuration, the answer selector 520 automatically selects one or more of the answers based on previous queries from the user, previous answer selections from the user, and/or a user profile. In another configuration, the answer selector 520 communicates to the user, requesting that the user select from the identified answers. To request that the user select from the identified answers, the answer selector 520 is in communication with the interface 110 to transmit the request to the user, as shown in FIG. 5C.

In use, the answer selector 520 is provided with multiple answers to a query. For example, in FIG. 5C, the answer selector 520 is provided with two answers to the query “Who has won the Masters?” The first answer is provided by the Golf DB 332 and relates to winners of the Golf Masters Tournament: “Tiger Woods, Phil Mickelson.” The second answer is provided by the Tennis DB 332 and relates to winners of the Tennis Masters Cup: “Roger Federer, Lleyton Hewitt.” The answer selector 520 requests that the user select from one of the two identified answers when a search combining both answers has a likelihood of being nonsensical. Based on the selected answer(s), the outputter 306 outputs the selected answer(s) to the search engine 140. The search engine 140 then searches for files based on the selected answer(s).

In one configuration, the comparator 510 (in FIG. 5B) determines that the identified answers substantially differ before the answer selector 520 requests that the user select from identified answers. In another configuration, the answer selector 520 requests that the user select from identified answers each time multiple answers are identified. In yet another configuration, the answer selector 520 determines whether substantially different answers are part of a single comprehensive answer before requesting that the user select from the identified answers.

For example, the News FAQ 336 may provide the answer “Jack Nicklaus” to the query “Who has won the Masters?” The answer selector 520 determines (e.g. by using repository 430) that “Jack Nicklaus” is part of a single comprehensive answer to “Who has won the Masters?” when “masters” refers to the Golf Masters Tournament. Therefore, rather than requesting that the user select between “Tiger Woods, Phil Mickelson” and “Jack Nicklaus” (each winners of the Golf Masters Tournament) the answer selector 520 selects both answers. The outputter 306 then outputs a combined answer “Tiger Woods, Phil Mickelson, Jack Nicklaus.”

The answer selector 520 may request that the user decide whether to transmit the multiple identified answers to the search engine as a single comprehensive answer to the query or as separate answers. When the user selects the latter, the search engine 140 executes a separate search based on each selected answer.

FIG. 5D illustrates a use of the outputter 306 of the identifier 120 when multiple answers are transmitted to the search engine 140. In FIG. 5D, the outputter 306 transmits separate answers separately to the search engine 140. For example, in FIG. 5D, the outputter 306 is provided with a first answer “Tiger Woods, Phil Mickelson” and a second answer “Roger Federer, Lleyton Hewitt.” The outputter 306 transmits each answer separately to the search engine 140. In FIG. 5D, the outputter 306 transmits “Tiger Woods, Phil Mickelson” in a first communication to the search engine 140, providing a basis for a first search. The outputter 306 also transmits “Roger Federer, Lleyton Hewitt” in a second communication to the search engine 140, providing a basis for a second search. The first and second communications may be transmitted sequentially or in parallel, depending on the configuration. Accordingly, the separate searches may be executed sequentially or in parallel. The results of each search are sent to the generator 160.

In another use, the outputter 306 transmits multiple answers as one answer to the search engine. For example, rather than transmitting “Tiger Woods, Phil Mickelson” in a first communication to the search engine 140, and transmitting “Roger Federer, Lleyton Hewitt” in a second communication to the search engine 140, the outputter 306 transmits “Tiger Woods, Phil Mickelson, Roger Federer, Lleyton Hewitt” in a single communication to the search engine 40, providing a basis for a single search.

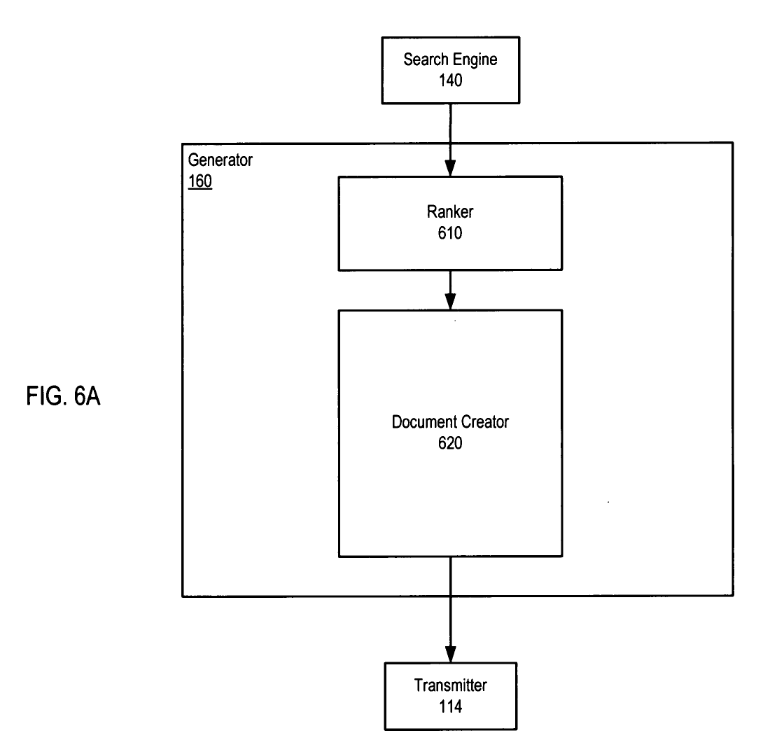

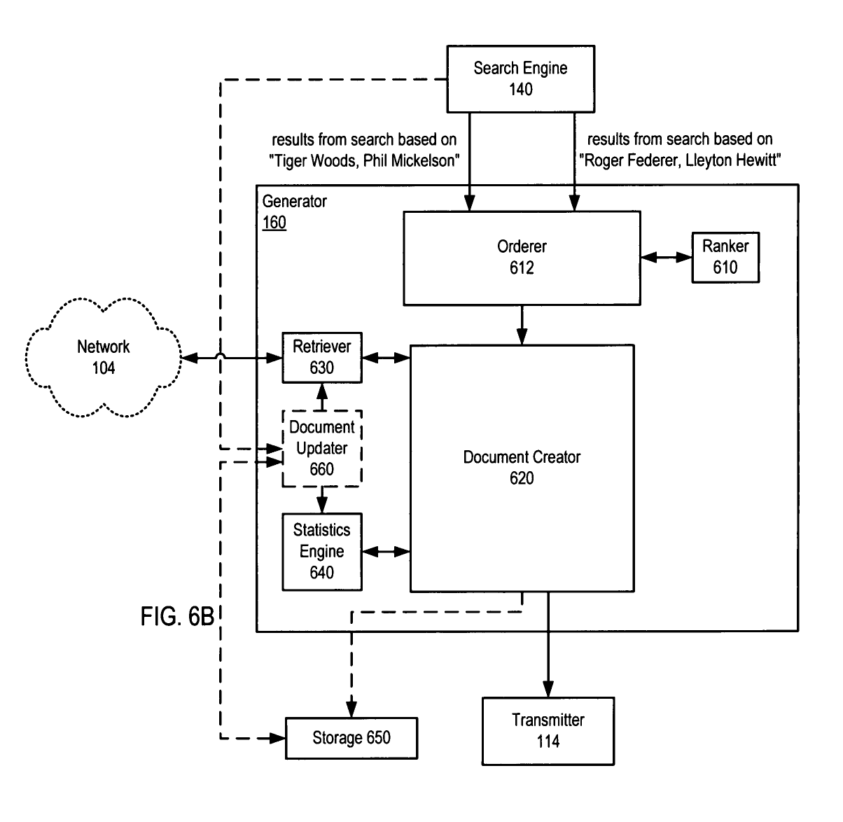

FIG. 6A is illustrates one use of the generator 160 of the system 108. In the FIG. 6A, the generator 160 includes a ranker 610 and a document creator 620. The ranker 610 is in communication with the search engine 140 and the document creator 620. The document creator 620 is also in communication with the transmitter 114.

In use, the ranker 610 receives from the search engine 140 results of one or more of the searches. The ranker 610 ranks the identified files. The ranker 610 then transmits the rankings to the document creator 620. The document creator 620 creates a document presenting the ranked files to the user in response to the query.

The ranker 610 typically ranks the files according to the number of answer terms in the file. That is, files associated with a greater subset of terms in the answer are ranked higher than files associated a smaller subset of terms in the answer. For example, in the scenario in which the query is “George H. Bush's children” and the answer is “George W. Bush, Jeb Bush,” the ranker 620 ranks a file associated with both “George W. Bush” and “Jeb Bush” higher than a file that associated with only “George W. Bush.” Accordingly, files more thoroughly associated with the user's original query, “George H. Bush's children,” can b e presented more prominently than files less thoroughly associated with the user's original query, e.g. files associated with only a subset of the answer.

As another example, in the scenario in which the query is “Winners of the Masters” and the multiple answers are combined into one answer “Tiger Woods, Phil Mickelson, Roger Federer, Lleyton Hewitt” to provide a basis for a single search (rather than two searches for example), the ranker 620 ranks a file associated with all of “Tiger Woods, Phil Mickelson, Roger Federer, Lleyton Hewitt” higher than a file that associated with only “Tiger Woods” and “Phil Mickelson,” or only with “Roger Federer” and “Lleyton Hewitt.”

In certain configurations, other factors are used, to rank the files. For example, factors such as click popularity, user reviews, last modification date, file creation date, file size, file location, file content source, and/or a user profile may be used to rank the files.

The weight given to each factor depends on the application of the invention. For example, when the invention is used to respond to queries for files available through the Internet, click popularity is weighted relatively heavily. However, when the invention is used to search for files indexed in a secure database, e.g. files profiling terrorists in a Central Intelligence Agency (CIA) database, access popularity of a profile file may be irrelevant. Therefore, a factor such as click popularity may be weighted lightly and a factor such as the number of answer terms associated with the file may be weighted heavily.

For example, when a user query is “Who has been involved in terrorist attacks in Britain?”, the user is probably more concerned with finding files discussing multiple terrorists, e.g. to assess a current threat. The user is probably less concerned with finding files discussing one terrorist in depth, else the user query would be directed towards describing that single terrorist, rather than directed towards discovering “who has been involved in terrorist attacks in Britain.” In such an application, in ranking the identified files, the system 108 is configured to weigh heavily the number of answer terms associated with a file and weigh lightly other factors.

In FIG. 6A, after ranking the files, the ranker 610 provides the rankings to the document creator 620. The document creator 620 creates a document presenting the files identified in the search. In FIG. 6A, the document creator 620 receives information about the files from the ranker 610, e.g. the file location and ranking. The document creator 620 creates a document (e.g. a web page) presenting at least a subset of the files and their locations. Higher ranked files are typically presented more prominently than lower ranked files, e.g. closer to the top of the document or in a certain format.

When a single file is identified and therefore not ranked, the document creator 620 can receive information about the file directly from the search engine 140 rather than from the ranker 610. The document creator 620 then creates a document presenting that single file.

FIG. 6B illustrates a further use of the generator 160 of the system 108. In FIG. 6B, the system 108 includes a storage 650. In FIG. 6B, the generator 160 includes the ranker 610, an orderer 612, the document creator 620, a retriever 630, a statistics engine 640, and an optional document updater 660. The search engine 140 is in communication with the orderer 612. The orderer 612 is in communication with the ranker 610 and the document creator 620. The document creator 620 is also in communication with the retriever 630, the statistics engine 640, and the transmitter 114.

In use, the orderer 612 receives search results from the search engine 140. In FIG. 6B, the orderer 612 receives results from two separate searches: a first result from a search based on “Tiger Woods, Phil Mickelson” ,and a second result from a search based on “Roger Federer, Lleyton Hewitt.”

The orderer 612 communicates with the ranker 610 to rank files identified in each search separately. For example, in the present example, the ranker 610 ranks files identified in the “Tiger Woods, Phil Mickelson” search relative to each other. Separately, the ranker 610 ranks files identified in the “Roger Federer, Lleyton Hewitt” search relative to each other. The rankings are then transmitted to the document creator 620.

In one configuration, the document creator 620 creates a separate document for each search. These separate documents may be displayed in separate browser windows on the client, for example.

In another configuration, the document creator 620 creates a single document presenting results of the multiple searches simultaneously. In such a configuration, the document creator 610 lays out the contents of the document in a manner which visually separates the files identified in each search, such as by presenting results of the searches in different sections of the document.

For example, in one application, a left side of the document provides links to files associated with winners of the Golf Masters Tournament, while a right side of the document provides links to files associated with winners of the Tennis Masters Cup. In another application, a first page of the document provides links to files associated with winners of the Golf Masters Tournament, while a second page of the document provides links to files associated with winners of the Tennis Masters Cup.

In one configuration, orderer 612 orders the search results according to a criterion other than the originating search. For example, in one application, the orderer 612 separates the results (whether from a single search or from multiple searches) into groups according to sources of the files. For example, when the system 108 is used in one e-commerce application, the orderer 612 separates advertisement files (e.g. files advertising paraphernalia relating to Tiger Woods and Phil Mickelson) from non-advertisements files (e.g. news articles discussing Tiger Woods and Phil Mickelson). The orderer 612 then ranks each group separately using the ranker 610.

After the files are ordered and ranked, the orderer 612 provides the order and ranks to the document creator 620.

In FIG. 6B, document creator is in communication with the retriever 630. The retriever 630 retrieves contents of one or more files identified by the search engine via a network (e.g. the network 104). For example, the retriever 630 may retrieve a news snippet, a review (e.g. a movie review), an image embedded within a file, a blog entry, or a link embedded within an identified file.

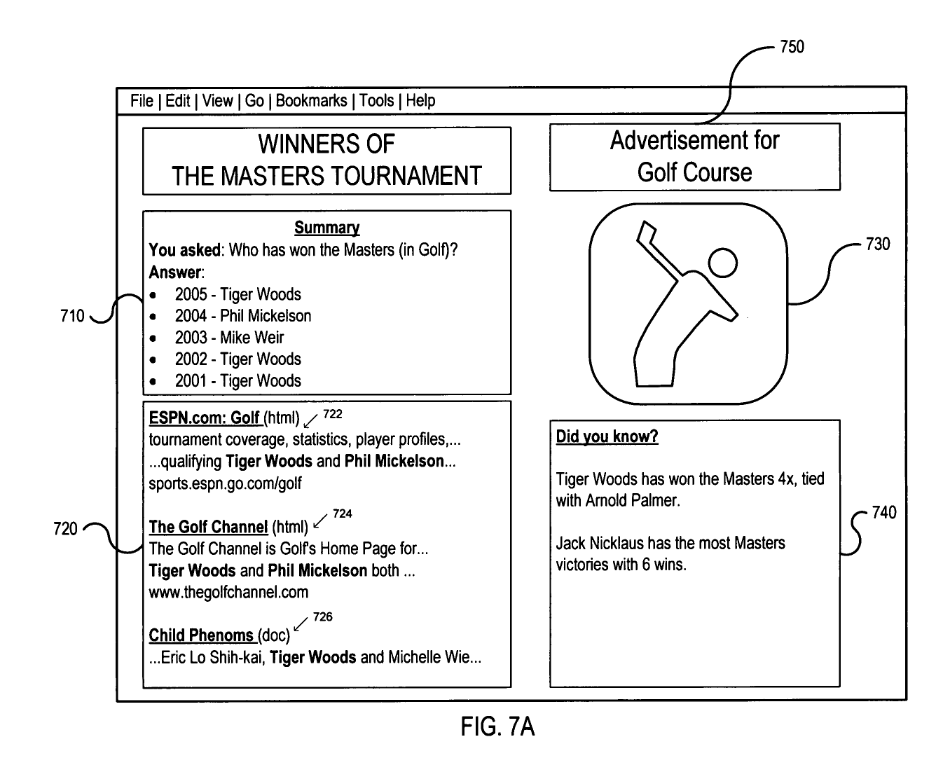

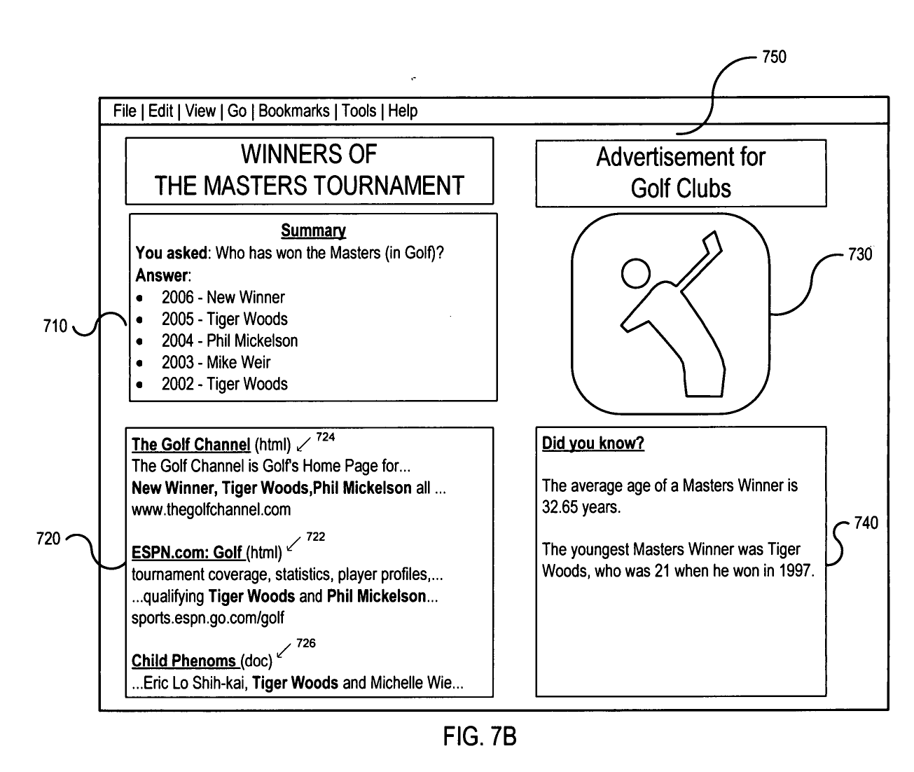

The document creator 620 uses contents of the files retrieved by the retriever 630 in creating the document(s). In one application, the document creator 620 inserts a news snippet into a summary section 710 or a trivia section 740 and an image into an image section 730 of a document, e.g. the document shown in FIG. 7A.

In FIG. 6B, the document creator 620 is also in communication with a statistics engine 640. The statistics engine 640 determines statistics relating to the answer(s) to the query and/or the query itself.

For example, in one application, the statistics engine 640 determines statistics for each of set of terms in an answer. In FIG. 6B, the statistics engine 640 determines one statistic based on “Tiger Woods” (e.g. the number of identified files associated with “Tiger Woods,”) and another statistic based on “Phil Mickelson” (e.g. the number of identified files associated with “Phil Mickelson”).

In one configuration, the statistics engine 640 communicates with the retriever 630 to base a statistic on contents of one or more files identified in the search based on the answer(s). For example, in one application, the statistics engine 640 communicates with the retriever 630 to retrieve contents of various news articles associated with Tiger Woods and Phil Mickelson. The statistics engine 640 then determines a statistic based on the content of the various news articles, such as an average number of times “Phil Mickelson” appears in the articles. In another application, the statistics engine 640 communicates with the retriever 630 to retrieve contents of a web page containing sports statistics. The statistics engine 640 then extracts those statistics and transmits them to the document creator 620. In one application, the statistics engine 640 calculates a statistic based on the extracted statistics.

In one configuration, the statistics engine 640 determines statistics based on the query itself, e.g. a number of times in the last month other users have submitted the same query. The statistics engine 640 provides these statistics to the document creator 620.

The document creator 620 uses statistics determined by the statistics engine 640 in creating the document(s) presenting the search results. In one application, the document creator 620 presents the statistics in the summary section 710 or the trivia section 740 of the document shown in FIG. 7A. The document creator 620 communicates with the transmitter 114 to transmit the document(s) to the user.

In one application, the document creator 620 also transmits the document(s) to the storage 650. The storage 650 stores documents which are provided as answer portals.

An answer portal is a stand alone document that provides answers to specific queries. Here, answer portals may provide answers to the queries “Who is Bill Clinton's wife?”, “Who are George H. Bush's children?”, and “Who has won the Masters?”. The documents provided as answer portals are accessible via a network, e.g. network 104.

Accordingly, in one application, a business may provide specific queries from which to generate answer portals based on answers to the queries. Because these answer portals are standalone and accessible via the network, search engines may identify these answer portals in a search for files. In certain applications, the documents provided as answer portals are purged from the storage 650 based on how frequently the answer portal is accessed.

Each answer portal presents at least one of: answer(s) to the query; a ranked list of files identified using the search engine 140 (e.g. web pages, news articles, blogs, reviews); content extracted from files identified using search engine 140 (e.g. content from web pages, news articles, blogs, reviews, images); files identified using the search engine embedded in the answer portal (e.g. images); and links to other answer portals containing information directly associated with each of the answers or each set of terms in an answer to the query. Each of these items may be ranked by ranker 610 prior to being arranged in the document. For example, in one application, the news articles snippets, blog entries, and reviews are ranked by how many of set of terms in the answers are included in the news articles, blog, and review. Accordingly, a snippet from a news article discussing both Tiger Woods and Phil Mickelson is ranked higher than a blog entry from a fan blog dedicated to Tiger Woods.

The documents are routinely and automatically updated. For example, in one configuration, each night, the analyzer 304 automatically analyzes the relevant structured data collections to determine an updated answer to the original query. For example, in one application, each night at 1 a.m., the analyzer 304 re-executes the SQL query “SELECT Golfers FROM Masters WHERE Winner=1” formed by the converter 410 against the Golf DB 332. In certain instances, the answer returned, i.e. the updated answer, is the same as the initial answer. However, in some instances, the updated answer is different, for example, because a new winner for the Masters was added to the database.

The search engine 140 then searches, based on the updated answer, the index to identify an updated set of files associated with the updated answer. The search engine executes the search regardless of whether the updated answer actually differs from the initial answer. Accordingly, files recently indexed and therefore not previously identified in the search may be discovered even when the updated answer and the initial answer are identical.

The search engine 140 transmits the results of the searching based on the updated answer (which may be identical to the initial answer) to the document updater 660. Based on the updated answer and the updated set of files, the document updater 660 uses retriever 630 and statistics engine 640 as appropriate to update the information in the document stored in the storage 650. Therefore, the answer portal, although a standalone page, is dynamically generated on a regular basis.

FIG. 7A is a screenshot of a document created by document creator 620 on a screen of a client 102. Specifically, FIG. 7A is a screenshot of a document generated to present results of a search based on one answer to the query “Who has won the Masters?” The document shown in FIG. 7A includes multiple sections 710, 720, 730, 740, and 750.

Section 710 is a summary section. In one application, section 710 presents a summary of the results of the search, e.g. the number of files identified and/or statistics regarding the files. In another application, section 710 presents a summary of the answer to the user query. For example, in the Masters application, the summary section presents a list of the Golf Masters Tournament winners. The summary of the answer may be based on data in index 150 describing the files (e.g. metadata collection by the bot), as well as contents of the identified files retrieved using the retriever 630.

Section 720 is a file location section. In use, section 720 presents locations of the files identified in the search. In certain applications, the locations are provided via links to the files. In other applications, the locations are provided as plain text. Section 720 typically presents only a subset of the files identified in the search (e.g. the highest ranking files), and presents a link to another document having links to other, lower ranked, files identified in the search. In FIG. 7A, files which are associated with a greater subset of the sets of terms in the answer are ranked higher and presented more prominently than files associates with a smaller subset of the sets of terms. Specifically, the web pages 722 and 724 associated with both Tiger Woods and Phil Mickelson are ranked and listed higher than the word processing document 726 associated with Tiger Woods, but not Phil Mickelson. Additionally, although web page 722 and 724 are each associated with both Tiger Woods and Phil Mickelson, web page 722 is ranked and listed than web page 724. In certain applications, this result is due to other ranking factors. For example, in certain applications, web page 722 has higher click popularity than web page 724 and is therefore ranked higher.

Section 730 is an image section. In use, section 730 presents an image associated with an answer to the query and/or the query itself. For example, in the Masters application, section 730 presents an image of Tiger Woods, Phil Mickelson, and/or the Augusta National Golf Club Course. In certain applications, the image presented in image section 730 is one of the files identified by the search engine 140, e.g. an image file found during the search. In another instances, the image presented in the image section 730 is extracted from one of the files identified by search engine 140. For example, if the image to be presented in section 730 is found embedded in a news article identified in the search, the retriever 630 retrieves the article and provides the image to the document creator 620 for insertion into the image section 730.

Section 740 is a trivia section. In use, section 740 presents trivia relating to an answer to the query and/or the query itself. In one application, section 740 presents statistics determined by statistics engine 640, as previously discussed. In a further application, section 740 presents factoids extracted from files identified by the search engine 140 and retrieved by the retriever 630.

Section 750 is an advertisement section. In use, section 750 displays advertisements for products and/or services related to the answer to the query and/or the query itself. The advertisement is retrieved from a separate database of advertisement, e.g. by the retriever 630.

FIG. 7B is a screenshot of the document of FIG. 7A after being updated by document updater 660. In FIG. 7B, the summary section 710 now displays an updated list of winners, including the winner of the 2006 Masters Tournament. Accordingly, when the document displays an initial answer, updating the information presented in the document may include displaying the updated answer in place of the initial answer.

The image section 730 now also shows a different image associated with the updated answer to the query and/or the query itself. For example, the image may be of the 2006 winner. Accordingly, when a file is embedded in the document (e.g. in the image section 730), updating the information presenting in the document may include embedding in the document, in place of the initially identified file, a file in the updated set of files (e.g. a different image file, music file, video file, multi-media file, applet, servlet, web page, or word processing file as appropriate).

The file location section 720 in FIG. 7B displays the same files, although they are ranked differently. In FIG. 7B, the web page 724 is ranked higher than web page 722 because web page 724 is associated with the New Winner as well as with Tiger Woods and Phil Mickelson while web page 722 is associated with only Tiger Woods and Phil Mickelson but not the New Winner. Accordingly, when the document displays a list listing of some or all of the files identified in the initial search, e.g. the top ten ranked files in the initial set of files, updating the information presented in the document may include altering the list to list the top ten ranked files in the updated set of files.

The trivia section 740 in FIG. 7B displays different trivia relating to the updated answer to the query and/or the query itself. For example, in certain instances, the trivia section 740 (or another section) displays a blog entry extracted from a blog, a news snippet extracted from a news article, a segment of text extracted from a web file or word processing file, a slide extracted from a multimedia file, and/or plays a song clip extracted from a music file or a video clip extracted from a video file. Some or each of those contents may be updated with content extracted from a file in the updated set of files, which may include some of the files in the initial set of files. Accordingly, when the document provides content extracted from a file in the initial set of files, updating the information presented in the document may include providing, in place of that content, different content extracted from a file in the updated set of files.

The advertisement section 750 has also changed to display a different advertisement. In certain configurations, the advertisement presented in section 750 changes independent of changes in the answer or in the set of identified files. Accordingly, in some instances, when a document stored in storage 650 is updated, information presented in the document may be updated even when the updated answer is identical to the initial answer and/or the initial set of identified files is identical to the updated set of identified files.

Additionally, in certain instances, information presented in certain sections is updated while information in other sections remains the same. For example, the information in the summary section 710 may not change because the answer to the query may be the same. However, the information in both the trivia section 740 and/or the advertisement section 750 may change to present different trivia and/or different advertisement.

Thus, a system and method for responding to a user query is disclosed. In the description above, numerous specific details are set forth in order to provide a thorough understanding of the present invention. However, it will be apparent to one of ordinary skill in the art that these specific details need not be used to practice the present invention. In other circumstances, well-known structures, materials, or processes have not been shown or described in detail in order not to unnecessarily obscure the present invention.

What is claimed is:

1. A method for responding to a user query comprising:
identifying an answer to a user query based on data in a structured data collection;
searching, based on the answer, a systematically-generated, automatically-updated index of remotely stored files to identify a file associated with the answer; and
generating a response to the query based on a result of the searching.

2. The method of claim 1, wherein the identified file is selected from the group consisting of: a web page, an image file, an audio file, a video file, a multi-media file, a word processing file, and a server page.

3. The method of claim 1, wherein the structured data collection includes a lookup table and identifying the answer comprises:
accessing the lookup table to determine one or more terms relationally or functionally mapped to the query.

4. The method of claim 1, wherein identifying the answer comprises:
parsing the query to identify keywords;
analyzing the structured data collection to identify one or more terms associated with the keywords; and
outputting the one or more terms as the answer.

5. The method of claim 4, wherein the structured data collection is a database and analyzing the database comprises:
forming a database query based on the user query; and
executing the database query against the database.

6. The method of claim 1, wherein generating the response comprises:
creating a document having a link to the file.

7. The method of claim 1, further comprising, when the searching identifies multiple files associated with the answer, ranking each of the multiple files.

8. The method of claim 7, wherein the ranking comprises:
ranking a first file higher than a second file when the first file is associated with a greater subset of answer terms than the second file.

9. A machine readable medium having stored thereon a set of instructions, which when executed, perform a method comprising of:
receiving a query originating from a user;
identifying at least one answer to the query based on data in at least one structured data collection;
transmitting the at least one answer to a search engine to search a bot-generated, bot-updated index of remotely stored files identifying files associated with the at least one answer;
determining an order for the identified files;
creating a document presenting the identified files based on the order; and
transmitting the document to the user.

10. The machine readable medium of claim 9, wherein transmitting the at least one answer comprises:
transmitting each answer separately to the search engine executing a separate search based on each answer.

11. The machine readable medium of claim 10, wherein determining the order for the files comprises:
grouping together files identified in each separate search.

12. The machine readable medium of claim 9, wherein the method further comprises:
when the at least one structured data collection is categorized into multiple categories, asking the user to select a category; and
identifying the at least one answer based primarily on data categorized into the selected category.

13. The machine readable medium of claim 9, wherein identifying the at least one answer comprises:
parsing the query to identify keywords;
analyzing the at least one structured data collection to identify, for each structured data collection, a set of terms associated with the keywords;
comparing the sets;
when non-empty sets substantially differ, outputting each substantially differing set as a separate answer;
when non-empty sets are substantially similar, outputting the substantially similar sets as a single answer having multiple terms including terms of the substantially similar sets; and
when each set is empty, outputting the keywords as the single answer.

14. The machine readable medium of claim 13, wherein the method further comprises:
when multiple answers are outputted, asking the user to select one of the multiple answers; and
focusing searching to identify files associated with the selected answer.

15. A device for responding to a user query comprising:
an identifier to identify an answer to a user query based on data in a structured data collection;
a search engine in communication with the identifier to search, based on the answer, a systematically-generated, automatically-updated index of remotely stored files identifying a file associated with the answer; and
a generator in communication with the search engine to generate a response to the query based on a result of the searching.

16. The device of claim 15, wherein the generator comprises:
a retriever to retrieve contents of the identified file; and
a document creator in communication with the retriever to create a document presenting the contents.

17. The device of claim 16, wherein the contents includes at least one of: a news snippet, a review, an image, a blog entry, and a link.

18. The device of claim 16, wherein the generator further comprises:
a statistics engine in communication with the document creator to determine statistics relating to the answer, the document further presenting the statistics.

19. A system for responding to a user query comprising:
a receiver to receive a query originating from a user;
one or more structured data collections to relate answer terms and query keywords;
an identifier in communication with the receiver and to the one or more structured data collections, the identifier to identify one or more answers to the query based on the answer terms and the query keywords related in the structured data collections;
a search engine in communication with the identifier to search a bot-generated, bot-updated index of remotely stored files identifying files associated with at least one of the one or more answers;
a ranker in communication with the search engine to rank the identified files;
a document creator in communication with the ranker to create a document presenting the ranked files; and
a transmitter in communication with the document creator to transmit the document to the user.

20. The system of claim 19, wherein the one or more structured data collections include a structured data collection selected from the group consisting of: a database, a lookup table, an extensible markup language (XML) seed, a spreadsheet, a tab-delineated list, a comma-delineated list, a space-delineated list, a frequency asked questions (FAQ), and a knowledge base.

21. The system of claim 19, wherein the identifier includes:
a converter to convert the query into a query language associated with analyzing at least one of the structured data collections.

22. A method for providing an answer portal comprising:
forming a database query based on a natural language query;
executing the database query against a database to determine an initial answer to the natural language query;
searching, based on the answer, an index of remotely stored files to identify an initial set of files associated with the initial answer;
presenting information associated with the initial answer in a document;
providing network access to the document; and
routinely and automatically updating the document, wherein updating the document includes:
re-executing the database query to determine an updated answer;
searching, based on the updated answer, the index to identify an updated set of files associated with the updated answer; and
updating the information in the document based on the updated answer and the updated set of files.

23. The method of claim 22, wherein presenting the information includes displaying the initial answer, and updating the information includes displaying the updated answer in place of the initial answer.

24. The method of claim 22, wherein presenting the information includes displaying a list listing at least a subset of the initial set of files, and updating the information includes altering the list to list at least a subset of the updated set of files.

25. The method of claim 22, wherein presenting the information includes providing first content extracted from a file in the initial set of files, and updating the information includes providing, in place of the first content, second content extracted from a file in the updated set of files.

26. The method of claim 25, where providing either the first content or the second content comprises displaying a blog entry extracted from a blog, displaying a news snippet extracted from a news article, playing a song clip extracted from a music file, playing a video clip extracted from a video file, displaying a segment of text extracted from a web file or word processing file, and displaying a slide extracted from a multimedia file.

27. The method of claim 22, wherein presenting the information includes embedding in the document a file in the initial set of files, and updating the information includes embedding in the document, in place of the file in the initial set of files, a file in the updated set of files.

28. The method of claim 27, where embedding either the file in the initial set of files or the file in the updated set of files comprises embedding at least one of: an image file, a music file, a video file, a multi-media file, an applet, a servlet, a web page, or a word processing file.

29. The method of claim 22, wherein presenting the information includes advertising a first service or product relating to the initial answer, and updating the information includes advertising a second service or product relating to the updated answer.
